(19) United States
(12) Patent Application Publication
(10) Pub. No.: US 2004/0194322 A1
(43) Pub. Date: Oct. 7, 2004

(54) Feeding implement

(76) Inventors: Hoke V. Bullard, Chatham, NJ (US); Daniel Lantz, Morristown, NJ (US); Charles Quinn, Sun Prairie, WI (US)

Correspondence Address: NOVARTIS, CORPORATE INTELLECTUAL PROPERTY, ONE HEALTH PLAZA 430/2, EAST HANOVER, NJ, 07936-1080, US

(21) Appl. No.: 10/644,329

(22) Filed: Aug. 20, 2003

Related U.S. Application Data
(60) Provisional application No. 60/459,331, filed on Apr. 1, 2003.
(60) Provisional application No. 60/478,708, filed on Jun. 13, 2003.

(51) Int. Cl. A47J 43/28

(52) U.S. Cl. 30/286; 30/326

(57) ABSTRACT

The present invention relates to a feeding implement that can be used for self-feeding by a child, such as a toddler, or an individual having a disability. The feeding implement consists of a handle and a transport portion which is shaped and suitable for dipping into solid foods, such as purees and infant cereal. The transport portion has on its surface multiple protrusions and/or grooves to increase its surface area.

### BACKGROUND OF THE INVENTION

The present invention relates to feeding implements, and in particular to a feeding implement designed for use by small children or those individuals having disabilities.

### FIELD OF THE INVENTION

A key milestone in the feeding development of a young child is the introduction of solid foods such as purees and other soft mixtures. Infants, or small children like toddlers, are commonly fed these “solid foods” with well-known eating utensils like forks, spoons and knives. Although these standard eating utensils can be easily handled by an adult for feeding to a child, a small child, herself, may have difficulty in grasping the utensil for self-feeding. These utensils typically have a handle and another portion for transporting food that must be properly oriented in order to prevent any spillage. For example, spoons must be oriented with their bowls up; otherwise there would be spillage of the contents. Small children and individuals having disabilities lack the manual dexterity to properly hold standard spoons and forks. Furthermore, such spoons and forks may also be used improperly potentially causing discomfort or injury. Thus, there is a need for a feeding implement that is appropriate for self-feeding by a small child.

### SUMMARY OF THE INVENTION

One aspect of the present invention is a feeding implement including a handle portion connected to a transport portion. The handle portion is shaped such that it can be easily grasped by a small child or an individual having disabilities. The transport portion is shaped such that it can be easily dipped into a container holding a solid food. The transport portion consists of a member extending from the handle portion and having a texture suitable for adhering purees and soft mixtures. Once the transport portion is dipped into the food, the food remains on the transport portion regardless of the orientation of the transport portion until the transport portion is inserted in the child's mouth.

In another aspect of the present invention, the texture of the transport portion has a high surface tension to facilitate adhesion of the soft food to its surface. In yet another aspect of the present invention, the transport portion features physical elevations or depressions that increase the surface area thereof to increase the quantity of food being transported.

Yet another aspect of the present invention further includes a mouth guard located in between the transport portion and the handle portion of the present invention. The mouth guard consists of flange, optionally configured to be anti-roll that prevents the transport portion from being inserted an undesirable distance into the user's mouth.

These and other features, advantages and objects of the present invention will be further understood and appreciated by those skilled in the art by references to the following specification, claims and appended drawings.

### BRIEF DESCRIPTION OF THE DRAWINGS

The accompanying drawings, which are incorporated in and constitute a part of the specification, illustrate an exemplary embodiment of the present invention.

FIG. 1 shows a side elevational view of a feeding implement in accordance with a first exemplary embodiment of the present invention;

FIG. 2 is a perspective view of the feeding implement of FIG. 1;

FIG. 3 is a front elevational view of the feeding implement of FIG. 1;

FIG. 4 is a cross-sectional view of the feeding implement of FIG. 1 taken along the line A-A;

FIG. 5 shows a side elevational view of a feeding implement in accordance with a second exemplary embodiment of the present invention;

FIG. 6 is a perspective view of the feeding implement of FIG. 5;

FIG. 7 is a front elevational view of the feeding implement of FIG. 5;

FIG. 8 is a side elevational view of a feeding implement in accordance with a third exemplary embodiment of the present invention;

FIG. 9 is a top plan view of the feeding implement of FIG. 8;

FIG. 10 is a perspective view of the feeding implement of FIG. 8; and

FIG. 11 is a front elevational view of the feeding implement of FIG. 8.

### DETAILED DESCRIPTION OF THE INVENTION

The present invention features a feeding implement that is appropriate for use by a small child that is beginning to self-feed. The small child can be an infant or a toddler that is being introduced to solid foods for the first time or one that has been eating baby foods and is transitioning to adult foods or table foods. As used herein, “solid foods” refer to foods that are commonly eaten in an infant's or toddler's diet and can include viscous liquids, such as those with honey-like viscosity, and semi-solid mixtures, especially purees, mashed foods and dips. “Honey-like viscosity” refers to a fluid properties similar or comparable to that of honey and not honey itself. Note that honey is not safe for infants under a year old. Examples of solid foods include, but are not limited to: vegetable purees, fruit purees, meat purees, infant cereals, oatmeal, mashed potatoes and mashed bananas. For example, fruit and vegetable purees available from Gerber Products Company (Fremont, Mich.) and sold as 1^{ST} FOODS, 2^{ND} FOODS and 3^{rd} FOODS are appropriate for use with the feeding implement of the present invention.

In addition to small children, the feeding implements can be used by individuals having a disability or individuals with a condition preventing them from having full manual dexterity, e.g., individuals with arthritis.

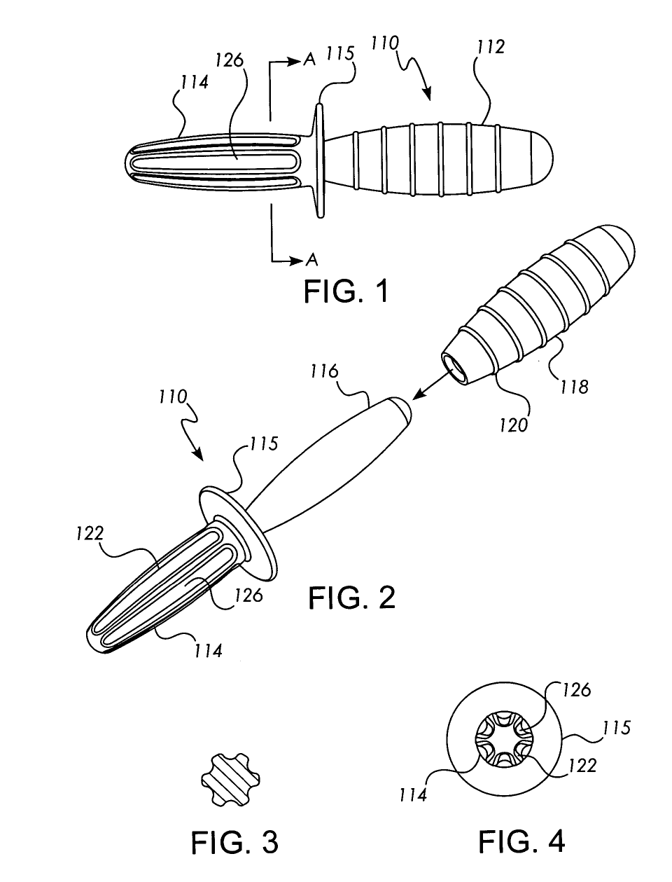

FIGS. 1 and 2 show side elevation and perspective views of a feeding implement respectively in accordance with an exemplary embodiment of the present invention. Feeding implement 110 includes handle portion 112 attached to transport portion 114, with an optional mouth guard 115 removably connected in between the handle portion 112 and the transport portion 114. The entire handle portion 112, e.g., is sized and shaped in dimensions suitable for holding by an infant or small child, for example from about 0.9 to 1.2 inches at its widest point. Moreover, the handle portion 112 can be tapered at either end for improved comfort. The handle 116 can consist of a rigid core (not shown) to provide structural rigidity to the feeding implement 110. The rigid core can be made of a material that has sufficient rigidity for handling by a small child, for example polypropylene. The rigid core can be covered, for example over-molded, by a soft polymer, e.g., polyvinyl chloride or an elastomeric polymer, such as SANTOPRENE, available from Advanced Elastomer Systems (Akron, Ohio) or KRATON, a styrene-butadiene elastomer from Shell Oil Company (Houston, Tex.). Optionally, molded on or onto the handle portion 112 is plurality of protuberances 120 which are present to aid grasping by the small child. The protuberances 120 can be a series of concentric ridges, as shown in FIGS. 1 and 2, or a spiral ridge. The protuberances 120 can also consist of discrete bumps or any other suitable shapes.

Although optional, it is desirable for the feeding implement 110 to have mouth guard 115. The mouth guard 115, e.g., consists of a flange located and removably attached between the transport portion 114 and the handle portion 112. The flange-shape of the mouth guard 115 can be, e.g., an ellipse, a circle or any other geometrical configuration. Furthermore, the mouth guard 115 can have radial indentations located along the perimeter thereof. The mouth guard 115 can be made from an elastomeric or semi-rigid polymer. The mouth guard 115 prevents the small child from placing the feeding implement 110 too far back into her mouth invoking an involuntary choking reflex. Furthermore, the mouth guard 115 also promotes proper hand placement on the handle portion 112.

Extending away from the mouth guard 115 is the transport portion 114. The transport portion 114 consists of member 122 that is symmetrical with respect to any axis when viewed from the front as shown in FIG. 3. As used herein “symmetrical” means correspondence in size, shape, and relative position of parts on opposite sides of a dividing axis.

It is preferable for the member 122 to be hard yet flexible. If the member 122 were too soft, then there may be a tendency for the child to gnaw on the member 122 like a teether. On the other hand, if the member 122 were too rigid, then the child may accidentally injure herself when feeding. Furthermore, the member 122 should not be so brittle that a child could bite off the member 122. The member 122 can have a straight or curved shape. The length of the member 122 should be of a sufficient length for transporting soft foods but not of a length so long that the member 122 becomes a choking hazard for the user. For example, the length of the member can range from about 16 mm to about 30 mm (measured from the edge of the mouth guard 115 to the end of the transport portion 114).

The outer surface of the member 122 should have a texture that allows for soft foods to adhere thereto. For example, outer surface can be an elastomeric polymer, such as polypropylene. Low surface tension materials, such as silicone and polytetrafluoroacetate may not provide enough adhesion for the soft foods.

In addition to the chosen materials, the physical shape of the member 122's outer surface may be chosen to optimize the adherence of soft foods. For example, FIGS. 1-4 show the member 122 having a plurality of flutes 126 such that the flutes 126 are arranged along the longitudinal axis, i.e., lengthwise, and substantially parallel to each other. As used herein, “substantially parallel” preferably means less than a twenty percent deviation from true parallel.

Longitudinally arranged flutes 126 allow the food to be smoothly scraped or licked off smoothly in a single continuous motion by the infant or child. In contrast, if the flutes were arranged “radially”, as in a honey dipper, then the transport portion 114 would not be easily removed from a child's mouth. The lips and/or tongue would ride up and down in a disjointed fashion after each successive flute were crossed.

The flutes 126 are, e.g., rounded grooves to maximize the surface area of the member 122. A larger surface area allows the member 122 to contact more food, and consequently pick-up more food. Each individual flute may have a depth from about 1 mm to about 3 mm, e.g., about 2 mm. In lieu of a rounded bottom, the flutes 126 may also have an angular groove. The member 122 can have from about 2 flutes to about 10 flutes in even or odd numbered arrangements. The flutes can be, for example, evenly or unevenly spaced from the next adjacent flute.

Also as shown in FIGS. 1-4, the surface of the member 122 consists of concave flutes 126 along the longitudinal axis. An alternative to the concave flutes 126 is to have a plurality of convex ridges also along the longitudinal axis, oriented parallel to each other. In either case, concave flutes or convex ridges, the surface area of the member 122 is greater than that of a smooth member with no elevations or depressions.

Another alternative exemplary embodiment that increases the surface area of the member 122 is to have a plurality of bumps (e.g., convex hemispherical elevations) on the outer surface of the member 122.

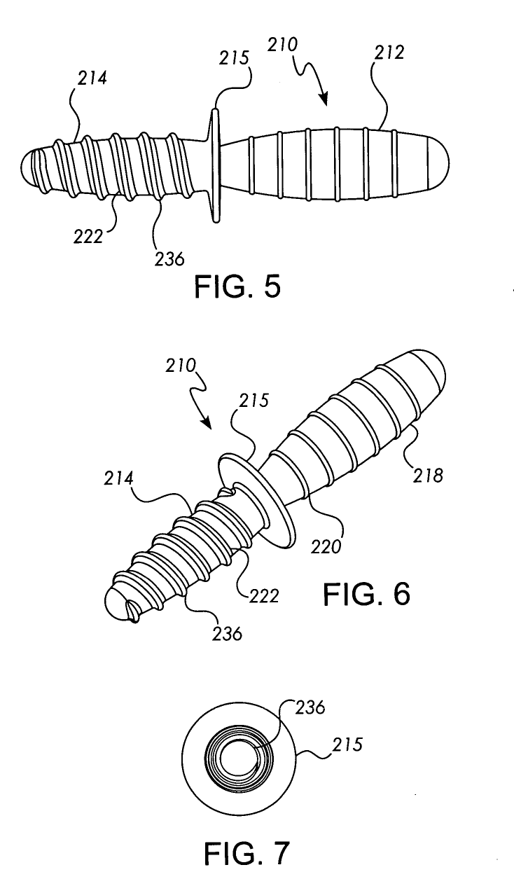

FIGS. 5-7, show an alternative exemplary embodiment of the transport portion 214 of the feeding implement 210 (with like parts relative to the exemplary embodiment of FIG. 1 being denoted by like reference numerals). In this particular embodiment, spiral ridge 236 is threaded or extends around the outer surface of the member 222. As shown in FIGS. 5-7, the spiral ridge 236 protrudes from the outer surface. The distance between each revolution of the spiral ridge from the next revolution is from about 0.5 mm to about 2.5 mm, for example about 1.5 mm. The pitch, e.g., of the spiral ridge can be from about from 1 mm to a high pitch of one or a quarter revolution per length of feeding end. The spiral ridge, for example, can also be broken or segmented. An alternative to this “threaded” embodiment, is to have a spiral trough extend around the outer surface of the member 222 instead of a spiral ridge.

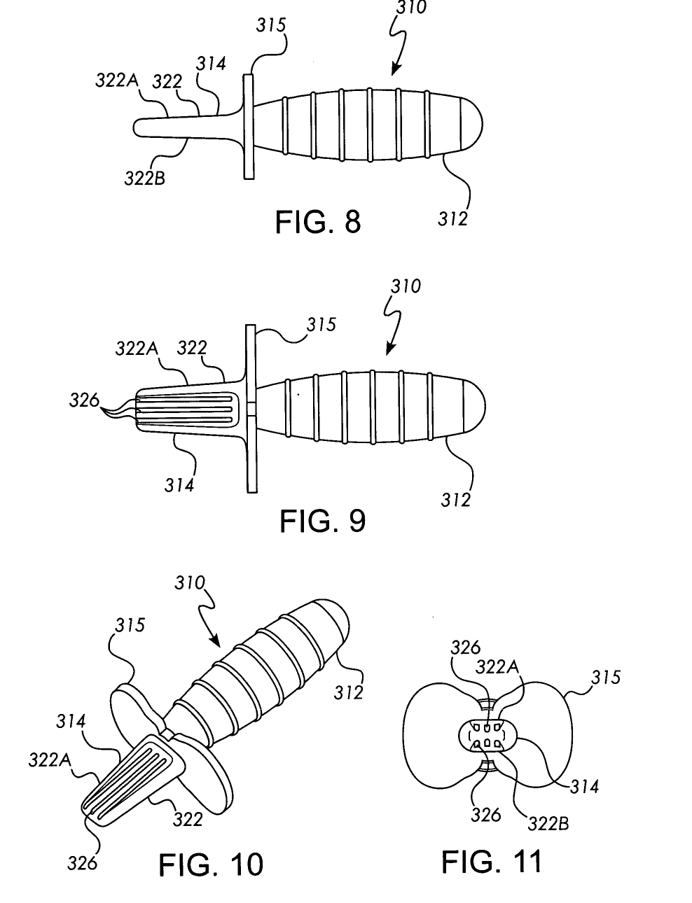

FIGS. 8-11, show yet another alternative exemplary embodiment of the transport portion 314 of the feeding implement 310 (with like parts relative to the exemplary embodiment of FIG. 1 being denoted by like reference numerals). In this particular embodiment, the member 322 of the transport portion 314 has top side 322a and bottom side 322b which have a concave or convex curvature that conforms to the shape of an arc that ranges from 0° to about 180°. For example, each side 322 can be flat, i.e., a 0° line, slightly curved, i.e., a less than or equal to 90° arc or, substantially curved, i.e., a greater than 90° arc. As used herein the term “substantially flat” refers to either flat or slightly curved in an arc less than or equal to 90°. The curvature of the sides 322 are independently the same or different. Furthermore, the curvature of the sides 322 can change the sides progress from the tip to the mouth guard 315, for example, the arc can change from about 25° to about 35°. The member 322 tapers away from mouth guard 315 such that the top side 322a and top side 322b meet at the end of the feeding implement 310. When viewed from the front, as in FIG. 11, the transport portion 314 is symmetrical with respect to the horizontal and vertical axes. The transport portion 314 is also symmetrical with respect to the horizontal axis, when viewed from the side as in FIG. 8. Oriented in the longitudinal axis of the member 322 and on each of the sides 322a and 322b are a plurality of grooves 326. Any number of grooves 326 can be on each side 322a or 322b with at least two grooves on each side 322a and 322b. Each of the grooves extend along the entire length of the member 322 with the bottoms of each of the grooves 326 concavely shaped to be curved, angular or polygonal. The grooves 326 can be oriented parallel to each other and be evenly or unevenly spaced from the next adjacent groove.

The mouth guard 315 has a shape such that the entire feeding implement 310 cannot roll when placed on an inclined or uneven surface. For example, for the feeding implement 310 to have this “anti-roll” feature, the mouth guard 315 should not have any points along its perimeter that is the only point tangent to the inclined surface. By having more than a single point in contact with an inclined surface at a given moment prevents the entire feeding implement 310 from rolling.

In the exemplary embodiments discussed above, the handle core does not extend into and through the transport portion. In another embodiment, the handle core can extend lengthwise through the entire feeding implement. In this embodiment, the outer surface of the member would be overmolded onto the portion of the handle core that extended therethrough. Having a handle core that supports the entire length of the feeding implement provides additional structural integrity and support.

When in use, the child dips the transport portion into a container holding the solid food, for example a bowl or jar. As the transport portion contacts the solid food, the solid food adheres to the various elevations and depressions of the transport portion. Because of the symmetry of the transport portion, the feeding implement can be oriented in various ways without the solid food spilling from the transport portion. The child then inserts the transport portion in her mouth and wraps her tongue and lips around the transport portion to remove the food. Unlike a spoon, the child can orient the feeding implement in any direction while handling the feeding implement without spillage.

It is understood that while the present invention has been described in conjunction with the detailed description thereof that the foregoing description is intended to illustrate and not limit the scope of the invention, which is defined by the scope of the following claims. Other aspects, advantages and modifications are within the scope of the claims.

What is claimed:

1. A feeding implement, comprising:
a) a handle portion shaped to permit grasping by a user;
b) a transport portion connected to said handle portion for dipping into solid food; and
c) said transport portion having an outer surface with a plurality of elevations located thereon, said elevations are oriented lengthwise along the longitudinal axis of said transport portion.

2. The feeding implement of claim 1, wherein said plurality of elevations are ridges.

3. The feeding implement of claim 1, further comprising a mouth guard connected in between said transport portion and said handle portion.

4. The feeding implement of claim 3, wherein said mouth guard is elliptical.

5. A feeding implement, comprising:
a) a handle portion shaped to permit grasping by a user;
b) a transport portion connected to said handle portion for dipping into solid food; and
c) said transport portion having an outer surface with a plurality of grooves located thereon, said grooves are oriented lengthwise along the longitudinal axis of said transport portion.

6. The feeding implement of claim 5, wherein said grooves are lengthwise flutes.

7. The feeding implement of claim 5, further comprising a mouth guard connected in between said transport portion and said handle portion.

8. The feeding implement of claim 6, wherein said mouth guard is elliptical.

9. A feeding implement, comprising:
a) a handle portion shaped to permit grasping by a user;
b) a transport portion connected to said handle portion for dipping into solid food; and
c) said transport portion having an outer surface with a spiral ridge threaded thereon.

10. A feeding implement, comprising:
a) a handle portion shaped to permit grasping by a user;
b) a transport portion connected to said handle portion for dipping into solid food; and
c) said transport portion having at least two substantially flat surfaces, each substantially flat surface having a plurality of grooves located thereon.
